(19) United States
(12) Patent Application Publication
(10) Pub. No.: US 2008/0104145 A1
(43) Pub. Date: May 1, 2008

(54) METHOD AND APPARTUS FOR BACKUP OF NETWORKED COMPUTERS

(76) Inventors: Derrell Lipman, Billerica, MA (US); Howell S. Richards, Westborough, MA (US); Larry Shoer, Lancaster, MA (US)

Correspondence Address: LAW OFFICE OF BRETT N. DORNY, 386 WEST MAIN STREET, SUITE 12A, NORTHBOROUGH, MA, 01532, US

(21) Appl. No.: 11/767,309

(22) Filed: Jun. 22, 2007

Related U.S. Application Data
(60) Provisional application No. 60/816,067, filed on Jun. 23, 2006.

(51) Int. Cl. G06F 12/16

(52) U.S. Cl. 707/204; 707/E17.007

(57) ABSTRACT

A backup device for a computer network is able to back up all shared files without the need to install software on the computers. A backup device, including a DVD drive, is connected to the network and includes all of the necessary software for execution. The backup device retrieves the files and directories for all computers on the network. A user can then designate the folders and files to be backed up. Folders are designated using different states which clarify the backup states of new subfolders and files. Backup files are stored based upon a digest of the file contents. The digest allows identical files, anywhere in the network, to be backed up only once. The folder system of the backup device uses the digests to determine storage locations for quick storage and retrieval. Encryption and key control are handled by the backup device in order to protect the backed up data.

### CROSS REFERENCE TO RELATED APPLICATION

This application claims priority to U.S. Provisional Patent Application Ser. No. 60/816,067, filed Jun. 23, 2006.

### BACKGROUND OF THE INVENTION

1. Field of the Invention

The present invention relates to backup storage of information on a computer or network. More particularly, it relates to a system and method for simple control of the backup process.

2. Discussion of Related Art

Computer data are often backed up, i.e., copied, to a storage medium other than the host computer's storage disk, to permit the recovery of the data as they existed at some point in time in the event of system failure or inadvertent loss of data. The data can be automatically backed up on a daily or other periodic basis and placed on an alternate storage device, such as disk, tape, or optical archive media.

With some desktop or portable personal computers, backup is done manually on an erratic schedule, with the user of the computer being responsible for keeping track of the backup media. There are backup applications that provide backup for data stored on these computers by writing to removable storage devices (e.g., diskettes) or to an additional tape or disk drive associated with the computer. These applications can have a facility for automatic backup but rely on the user to insert backup media in a timely manner and to maintain control of the media.

Security of data is also a concern. Typically, encryption or password protection is used to protect backup data. A weakness with this method of archiving data is that a decryption key must be generated and utilized in order to have any meaningful access to the archived data or a robust password must be carefully chosen and remembered. To decrease the likelihood of any rogue discovering the decryption key, for example, such keys are generated to result in a seemingly random and meaningless string of symbols. In addition to this string of symbols being very difficult to guess, it is also very difficult to commit to memory. Thus, the decryption key is generally stored in some sort of retrievable format to enable later decryption of the associated encrypted data. One of the most common locations for storage of the decryption key is on the computer system itself.

Failing to secure the decryption key results in even the most advanced encryption scheme failing to provide security. Once the decryption key is available all of the encrypted data falls prey to prying eyes.

Backup copies of information stored on a computer system must be made so that if a failure occurs which causes the original copies of the data to be lost, the lost data can be recovered as it existed at the time when the last backup copy was made. Backup/restore systems have a long history on all types of computer systems from mainframes to minicomputers, local area network file servers and desktop workstations.

Historically, backup systems have operated by making copies of a computer system's files on a special backup input/output device such as a magnetic tape drive, floppy diskette drive, or optical disk drive. Most systems allow full backup, partial backup (e.g., specified drives, directories, or files), or incremental backups based on files changed after a certain date or time. Copies of files made during a backup procedure are stored on these special backup devices and are then later retrieved during a restore operation either under file names derived from the original file, from the date/time of the backup operation or from a serially-incremented, numbered, removable storage media. The backup procedure is typically accomplished on an individual computer/file server basis, rather than through a single coordinated approach encompassing multiple systems. That is, typically, backup storage media is connected to a single computer. That computer can back up itself directly to the storage media. In order for other computers on a network to back up, they have to determine the files to be backed up and then transfer those files to the other computer to be stored on the backup storage media.

Today, the absolute numbers of computers networked together by organizations are increasing rapidly as is the number of different types of computers and operating systems in use. At the same time, the number of storage devices and the capacities incorporated into each of these units is growing even more rapidly. In this environment, the backup/restore approaches which have been traditionally used have become less reliable, more expensive, and more consumptive of human time and attention.

### SUMMARY OF THE INVENTION

The present invention substantially overcomes the deficiencies of the prior art through use of a backup device which connects to the network and method for operation thereof. According to one aspect of the invention, the backup device includes a DVD drive for storage of backed up files. The backup device also includes a hard drive for temporary storage of files and for control of the backup process. According to another aspect of the invention, the backup device queries all computers on the network to retrieve shared file information. The backup device is able to automatically backup all shared files. A user may designate which files should be backed up.

According to another aspect of the invention, the backup uses a designation system for identifying folders and files to be backed up. The designation system allows improved applicability to new files and folders. The designation system allows four states for each folder—backup, do not backup, backup with exceptions for subfolders or files, and do not backup with exceptions for subfolders or files. When a new subfolder or file is found, its initial state is set to that of the folder in which it exists. According to another aspect of the invention, a sparse exception tree is used to represent the states assigned to the folders and files. According to another aspect of the invention, exception rules are used to set states for folder or files. The exception rules define conditions for which a folder or file will differ from the standard backup process. According to another aspect of the invention, the designation system for identifying folders and files is also used during a restoration process from the backup files. According to another aspect of the invention, an exception tree and exception rules can also be used during a restoration process from the backup files.

According to another aspect of the invention, the timing of the backup process is controlled for efficient backup. A default priority level is defined for back up of files and folders or the user may assign an alternate priority level. Files are backed up based upon the priority level and a time since last backup. Alternatively, a timed schedule can be set for backing up files.

According to another aspect of the invention, the files are stored in an efficient manner for backup and retrieval. A digest is created for each file. The digest is used as the file name. Files with the same digest, anywhere on the network, are identical and are only stored once. According to another aspect of the invention, the digest is used to locate the file within a directory system. The directory system includes multiple levels based upon parts of the digest name.

According to another aspect of the invention, the backup process occurs with minimal user action. Files are first backed up to a hard drive. When a sufficient amount of data has been backed up, a DVD disc image is created for the data. The DVD disc image may be stored on the hard drive until a DVD can be created. The hard drive may also include multiple DVD disc images for fast retrieval. According to another aspect of the invention, DVD disc images may be created at certain time intervals whether or not sufficient data has been backed up.

According to another aspect of the invention, the backed up data is encrypted for protection. The backup device maintains the encryption key. Thus, the backed up data can only be read with the proper backup device. Additional copies of the encryption key may be created in case of failures or other problems. The encryption key copy may also be used as an authentication mechanism for high level operations of the backup device.

### BRIEF DESCRIPTION OF THE DRAWINGS

FIG. 1 is a block diagram of a computer system utilizing a backup system according to an embodiment of the present invention.

FIG. 2 is a block diagram of a backup system according to an embodiment of the present invention.

FIG. 3 is a function diagram of memory for a backup system according to an embodiment of the present invention.

FIG. 4 is a user interface for backing up data according to an embodiment of the present invention.

FIGS. 5A-5C are a user interface for restoring data according to an embodiment of the invention.

### DETAILED DESCRIPTION

The present invention relates to a device and method for backing up files on a computer, computer system, and/or network of computers. The device provides a backup process which is intuitive for users, making it easy to install and operate. Despite its simplicity in user operation, the device and method are extremely robust in that they provide many features and capabilities for controlling the backup process. Furthermore, parts of the functionality of the backup device can be used in connection with other types of devices and methods. The present invention includes all such devices and methods.

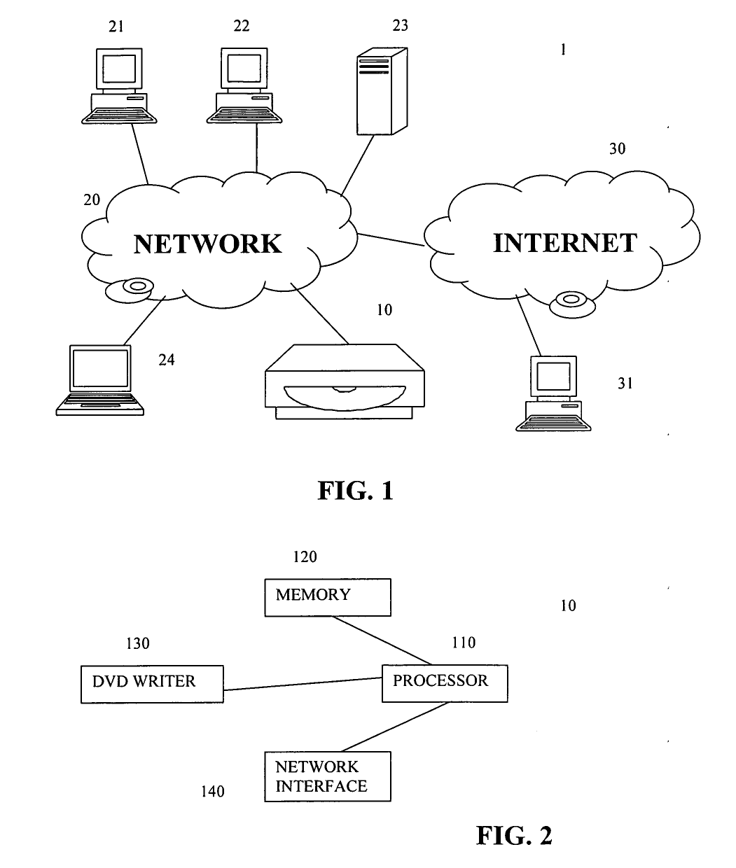

According to an embodiment of the invention, computer backup is controlled by a device independent of the computers being backed up. The device includes the processing power, programming, memory, mass storage drives, and computer interfaces necessary to complete the backup process. No additional software needs to be installed on any of the computers containing information to be backed up. A configuration for operation of the device is shown in FIG. 1. FIG. 1 illustrates a computer system 1 having a plurality of computers, including desktop computers 21, 22, servers 23, and laptop 24, connected in a network 20. A wide range of computers and networks can be used with the present invention. The computers may use any operating system, including Microsoft Windows, Apple Mac OS X, Linux, and Unix. Of course, the system could be used with other types of operating systems and computer networks through appropriate modification of the processes and procedures in order to interface with such systems.

A backup device 10 is connected to the network 20 so that it can communicate with any of the computers on the network. The backup device 10 may be connected to the network in any known manner. The backup device 10 is automatically set up with appropriate encryption and other technology to maintain the security of the network.

FIG. 2 illustrates the components of the backup device 10, according to an embodiment of the invention. The backup device 10 functions as special purpose computer and, thus, includes a processor 110 and memory 120. The memory 120 stores appropriate programming for execution in the processor 110 to perform the functions for the backup device as discussed below. The description of operation of the backup device 10 is representative of its capabilities. Of course, those of skill in the art will be able to provide appropriate programming to achieve these functions, as well as to provide additional capability. While the backup device 10 is illustrated as a special purpose computer, it could be of any format. An appropriately programmed general purpose computer could also be used to perform the functionality of the backup processes. Furthermore, an existing computer on the network could be utilized for the backup device. However, use of a special purpose device provides certain advantages with respect to capability, resource availability, speed and memory usage.

In addition to the memory 120 and processor 110, the backup device includes a DVD drive 130 and a network interface 140. The DVD drive 130 is used to create physical media of backup data or files. The physical media can be removed off site for additional security, in case of a fire or other destruction of equipment or stored backups. The processes and procedures described below in connection with operation of the DVD drive 130 can be easily adjusted by those of skill in the art to accommodate different types of physical media, such as higher density optical discs, floppy discs, compact data discs, tapes, flash drives, etc. The firmware of the DVD drive 130 may include the programming necessary to control reading and writing data to a DVD disc. Alternatively, the programming for control of the DVD drive 130 may be included in the memory 120 of the backup device and executed on the processor 110. Of course, the processor 110 must be programmed to interact with and provide the data to the DVD drive 130.

The network interface 140 is used to connect the backup device 10 to the network 20. Any type of interface can be used, and the type of interface will depend upon the network. A backup device 10 according to the present invention is particularly useful for small networks. Such networks often use an Ethernet connection. Thus, the network interface 140 would include an Ethernet connection.

FIG. 3 illustrates organization of at least a portion of the memory 120 of the backup device 10. In addition to storing the programming for the backup device 10, the memory 120 is used to store files for backup, copies of backup data, and a database for use in creating and restoring backup data. As discussed in further detail below, the memory 120 includes an index 150 for all of the data which has been backed up. This index 150 is in the form of one or more databases for storing information relative to the backups. In particular, the index 150 includes an exception tree 151, a file tree 152, and a listing of file digests 153. The file tree 152 is a tree representing information about files and folders of the entire network 20, including the files and folders for all computers which are or ever have been connected to the network 20. The file tree 152 further includes data for each file or folder within the tree. The data may include the path, attributes (size, access control lists, etc.), and times when the file was backed up. The file tree 152 also identifies one or more file digests of the data associated with each file. The file digests 153 are listings of data which have been backed up. It includes a unique identifier for each piece of data and where the backup file for that data is located. The exception tree 151 is associated with the file tree 152 and provides information used by backup device 10 to control scheduling of backup operations and to quickly determine which files or folders are to be backed up.

A portion 160 of the memory 120 is used to store information relating to data stored on the DVD media. The DVD portion 160 of the memory 120 has areas 161-164 for data corresponding to N+1 DVDs. One of these areas 161 stores currently backed up data. As data is copied from computers on the network 20 to the backup device 10, it is written to the Current DVD area 161. When the Current DVD area 161 is full, meaning that the data for a full DVD is complete, the data is transferred to an empty one of the disc image areas 162-164. A disc image area 162 stores all of the data for a single DVD. A DVD can then be created from the information in a disc image area 162-164. This allows the user to insert and create physical DVDs at times which are convenient. The data remains stored in the disc image areas 162-164 even after a DVD has been created. This allows more than one DVD to be created for the same data. Copies of the DVDs can be kept in different locations for improved security and recoverability.

Operation of the backup device 10 will now be described. When connected to a network 20, the backup device uses an appropriate Windows or other operating system protocol, to obtain information relating to all shared folders on all computers on the network. Only files in shared folders can be backed up. These are the only files which are accessible by the backup device 10 over the network using existing network software. Of course, the backup device 10 could use some other software or protocol to determine files on the computer. Additionally, software could be installed on the computers of the network which allows non-shared folders or files to be located and accessed by the backup device 10. Security can be used on the network to provide access to the backup device 10 without making files generally available to anyone on the network. A special username and password can be used by the backup device 10 to access files and folders on any computer. The information from the network 20 is used to add entries to the file tree 152 in the index.

Once computers and their shared folders have been located and added to the file tree 152 in the index, files and folders in those shared folders may be selected for backup. Typically, a network administrator would identify the files and folders. Of course, any user may be responsible for control of the backup device 10. The administrator or user accesses the backup device 10 through an ordinary browser, such as Internet Explorer. The backup device 10 is programmed to communicate with a browser using a secure connection (https). The administrator must enter an ID and password to get access to information on the backup device. An advantage of this implementation is that the backup device 10 can be accessed from anywhere with a network connection. The administrator may be at any computer on the network 20. Additionally, the device may be configured so that an administrator can use a computer 31 connected to the network 20 through the Internet 30. This allows remote access and control. Of course, the backup device 10 could limit access to a particular computer, a particular location, or to locally-networked devices only. Alternatively, the backup device 10 could include a keyboard and monitor for direct access.

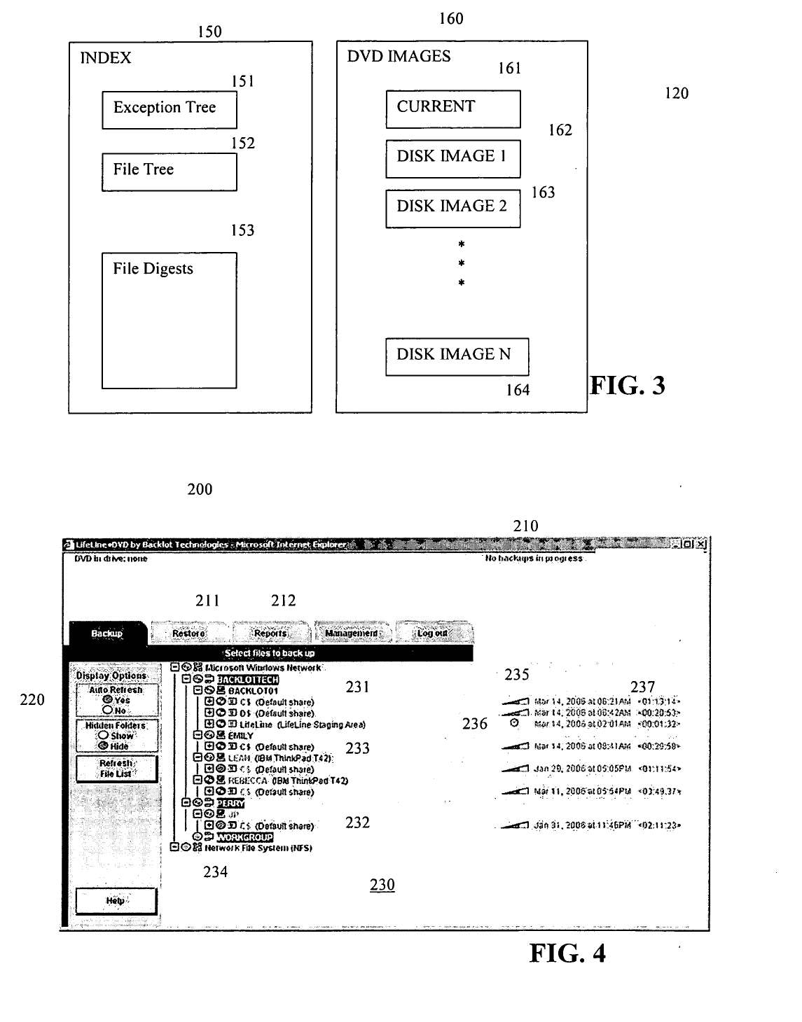

FIG. 4 illustrates a user interface 200 for access to the backup device 10 to control the backup process. The user interface 200 allows various processes to be selected by tabs 210. Processes may include Backup 211, Restore, Reports, and Management. FIG. 4 illustrates the Backup process tab 211. The Backup process tab 211 allows the administrator to set up and control backups. Display settings 220 are selected on the left hand side of the screen. These include whether hidden folders are displayed. In the backup device, certain folder names may be hidden. This is used to simplify the display. For example, folders which are not to be backed up can be hidden. The administrator can, of course, decide to view all folders in the listing. Higher level groupings on the network, such as computers or workgroups, may be treated in the same manner as folders, i.e. displayed or hidden with the file tree display. The main portion 230 of the display provides information regarding computers and shared folders from the file tree 152. The administrator may expand or contract the file tree 152, in a known manner for a file listing, in order to view portions of the tree. Information regarding the contents of shared folders in the file tree 152 is obtained in real time by querying the contents of the shared folders over the network 20. From the user interface 200, the administrator can identify folders and files for backup.

According to an embodiment of the invention, a unique system is used for selecting and identifying files for backup. It is common for software products, in particular backup products, to use a three-state model to indicate the selection status of nested folders in a file system or other tree-like hierarchies. In such systems, one state indicates that the folder and its contents are selected, a second state indicates that the folder and its contents are not selected, and a third state (“partially selected”) indicates that some of the contents of the folder are selected and some are not selected. Typically, these states are indicated graphically with a white square with a checkmark, an empty white square, and a gray square with a checkmark. However, such a system proves problematic for a backup system for which new entries are being made. In particular, for the partially selected state, the desired state of the new files cannot be determined. Thus, they are either always selected or never selected. The administrator must verify the status of each new file. This can be particularly tedious. The present invention utilizes a four state system, as illustrated in FIG. 4 to avoid the ambiguity of the partially selected state.

The scheme of the present invention uses the first two states, selected and not selected from ordinary schemes. However, the present invention replaces each single “partially selected” folder state with one of two distinct folder states:

a) folder is selected, but some (or all) of the contents of the folder have been de-selected

b) folder is not selected, but some (or all) of the contents of the folder have been selected.

Using this method, a newly created item is always considered selected or not selected depending on the state of its containing folder. Thus, an item in a selected folder is always initially/by default selected whether or not other items in the folder are not selected. An item in a non-selected folder is always initially/by default not selected, whether or not other items in the folder are selected. Graphically, the four states are represented in the interface as an empty oval 234 for a folder not selected; a solid oval 232 for a selected folder; a solid oval with empty dots 233 for a folder selected, but items in the folder not being selected; and an empty oval with solid dots 231 for the folder not selected but items in the folder being selected.

The selection states are maintained for all folders and files as changes are made to the file list. For example, if a folder is selected and one of its files or subfolders is deselected, then the folder automatically changes to the selected with exceptions state. Similarly, when all of the files and subfolders within a folder have a selected state as the result of a change in state or removal of a non-selected item, the state of the folder is changed to the selected state. Similar changes are made for changes within folders having non-selected states. Additionally, since the folder list is hierarchical, any folder changes may require changes to its ancestors within the tree. Every addition, change and deletion requires review of and possible change in state of ancestors of the file or folder which was altered.

The four state selection scheme of the present invention can be used in other contexts in addition to use with an embodiment of the backup device. Many types of information are maintained in hierarchical systems. Often, such information may require selection of information within the hierarchical system. The four state selection scheme of the present invention may be used for any such system. For example, the folder system on a computer has many uses in addition to the need to back up information. The scheme of the present invention could be used for access control by authorized users on a computer system. Searching algorithms, particularly assisted searching algorithms, may also utilize the selection scheme of the present invention. In connection with searching various types of information, a user may create large numbers of search terms or criteria. These search terms may be retained for future searches. With a large number of search terms, a hierarchical system can be used to organize the terms. The user may then select or deselect individual terms, categories or subcategories of terms. The selection scheme of the present invention can also be used for such a structure. Of course, many other extensions and uses of the selection scheme of the present invention will be clear and known to those of skill in the art. Any selection of information within a hierarchical system may benefit from use of the selection scheme of the present invention.

The present invention has been described with a four state scheme which is useful in the backup process. Any level of states could be used as necessary to obtain a desired level of specificity with respect to selection criteria. For example, there may be reasons to determine the number of exceptions within a folder. Numbers or percentages of exceptions could be represented by different states. Different types of exceptions may be possible within a selection scheme. The types of exceptions may be represented as different states. Furthermore, a multiple state scheme allows some selection states to be conditional. For example, a folder may be selected (or files within that folder selected) only when the last backup was longer ago than a defined period. Multiple state schemes can be easily represented on the user interface using different colors or shapes to represent the states.

Using the four state scheme of the present invention also provides a very easy way to keep track of which items are selected and which items are not. In common usage, the selected state of an item (file or folder) is maintained with the whole (possibly very large) set of items (files and folders). If a high-level selection state change is made, then each descendent item must be found and its selection state changed to concur with the requested change. In the present invention, the selection state of the entire tree is represented using a separate sparsely-populated tree, the exception tree 151. The only items that need to be maintained in the exception tree are items whose selection state differs from their immediate parent folder's selection state or one or more of whose descendents have a selection state which differs from the immediate parent folder's selection state.

The algorithm for making a selection change uses as input, a path, and an exclude flag that provides a binary truth value true or false (bExclude). A true value for bExclude means that the item is not selected. For a parent node, it may or may not have exclusions, i.e. child nodes which are selected.

If the parent node in the exception table already exists, AND the parent node has the same value of bExclude as the bExclude input parameter AND the parent node has only this one child node, then do nothing other than delete this node of the exception table (and all of its children) and remove successive ancestor nodes as long as they have the same value of bExclude as the bExclude input parameter.

Otherwise, the ancestor path nodes in the exception hierarchy are added, if they do not already exist. The bExclude value of each node created is inherited from its immediate parent down to, but not including the final component of the path. That final component gets a bExclude value given by the bExclude parameter.

If the full path already exists in the exception table, then all child nodes of that path are deleted and the bExclude component of the existing final component is changed, if necessary, to the value given by the bExclude parameter.

There are two algorithmic methods of retrieving selection states from the exception tree. One can quickly determine the selection state of a specified path by searching for the path in the exception tree. The state is determined as:

Include. Include this file or directory; no exceptions. This exact path exists in the exceptions table, and specifies Include, and there are no child nodes.

Exclude. Exclude this file or directory; no exceptions. This exact path exists in the exceptions table, and specifies Exclude, and there are no child nodes.

Include-Except. Include by default, but there are child nodes, indicating the existence of exceptions.

Exclude-Except—Exclude by default, but there are child nodes, indicating the existence of exceptions.

None. No exception information available for this path, i.e. it doesn't exist in the exception table.

When descending through a file tree, the state of “None” indicates to use the same selection state as the parent. If, however, the explicit selection state of a path is required, then this additional step can be incorporated:

Walk up the path (visiting each parent) until finding a parent with an explicit selection state, and provide that state. This method therefore always provides either Include or Exclude.

The exception tree structure also has uses beyond the backup device of the present invention. Any use of the selection scheme may include use of the exception tree for easily accessing and controlling information about selection states. Furthermore, the exception tree structure could be used with any selection of hierarchical data, whether the four state selection scheme is used or not. The data in the exception tree only represents whether a specific file, folder or other item in the hierarchy is selected. The structure of the file tree and the exception tree then represents the other states in the four state selection scheme. A three state system may also be implemented using the exception tree.

In addition to the selection schema, the backup device uses an exclusion rule system to define the type of folders or files which should not be backed up, even if they would otherwise be selected. A number of default rules may be provided with the backup device 10. The administrator may modify, delete, or create new rules. The rules can specify that all files or all folders that match a certain naming pattern or other criteria, e.g. the file's or folder's attributes such as size or permissions, will be excluded from backup. According to an embodiment of the invention, each rule contains the following components:

| Name of rule | |
|---|---|
| Description of rule | |
| This rule is | |
| -- enabled | |
| -- disabled | |
| Exclude from backup ... | |
| ... any discovered | |
| file | |
| folder | |
| ... whose name | |
| exactly matches: | |
| contains: | |
| starts with: | |
| ends with: | |
| | (character string) |

```
AND
... whose immediate parent folder is
    a top-level shared folder
    a normal folder (not a top-level shared folder)
    either a top-level shared folder or a normal folder
(optional)
AND
... Whose immediate parent folder's name is:
    (leave blank to match any parent folder name)
(optional)
AND
... Any ancestor folder name exactly matches:
    (leave blank to match any ancestor folder name)
```

Additionally, path names may be matched against any regular expression, allowing for fully arbitrary matching. The exclusion rule system allows certain types of files and folders to be excluded. Generally, this will be used for files for which backup serves no purpose, or would be undesirable. For example, computer systems store a multitude of temporary files. A copy of web pages retrieved are typically stored as a temporary file. These do not generally need to be backed up. Additionally, computer users may wish to create or store personal files on their computer. They may not want others to possibly have access to such files. Thus, personal files should not be backed up. Rather than require an indication of all personal files, an exclusion rule can be used to prevent backup of any files in a folder called “personal.” Computer users can then place any files they do not want backed up in such a folder. Exception rules may also be used to select or not select folders and files based upon information relating to the computer or system, rather than just on information about the files or folders. For example, the selection state may be based upon the operating system of the computer being selected. Alternatively, the types of files which fall within exceptions may depend upon the relevant operating system. Many types of exception rules are possible with the backup device of the present invention.

Again, the exclusion rules are not limited to use with the backup device of the present invention. They may be used in any environment where selection of information is necessary. In the backup device of the present invention, the user must designate which files and folders are to be backed up. The selection scheme, exception tree, and exclusion rules provide a framework for automatic designation of files and folders in accordance with certain criteria. Of course, the user may alter the standard criteria, but the system itself correctly selects most desired information. The four state selection scheme provides improved control for standard decisions based upon storage locations or associations. The exclusion rules provide exceptions for certain types of files or folders within the selection scheme. These functions may be included within any hierarchical system requiring selection or designation of information. A selection scheme provides a standard process for automatic selection based upon relationships. Exclusion rules provide exceptions within that scheme for certain types of information.

In addition to setting the selected or non-selected state for each folder and file, the administrator sets the backup timing according to a scheduling algorithm. According to an embodiment of the invention, a modified round robin scheduling algorithm is used. The system provides a default relative priority value for all selected folders and files. The administrator can set or change the relative priority on each shared folder that contains files to be backed up. According to an embodiment of the invention, the available priorities are called: As often as possible, Frequently, Periodically, Occasionally, and Rarely. According to one embodiment of the invention, the default priority is “Frequently.” This causes backups of new files to begin automatically, without the need to schedule the backup of the file. Of course, more or fewer priorities, different names or frequencies of priorities, and a different default priority may be used. The priorities are represented in the user interface by triangles 235 next to each folder. The extent to which each triangle is filled represents its priority. Thus, the user interface 200 easily represents to the administrator the priorities set for each folder. The administrator can then review and adjust the priorities as needed. Furthermore, the user interface identifies the time 237 of the last completed backup for each folder and how long that backup took to complete.

An algorithm, based on the priority selection and the time since each shared folder was last backed up, is used to determine which shared folder on the network to scan next for new and changed files. The algorithm begins by calculating the time since each shared folder was last backed up. In one embodiment of the invention, the time since the last backup is multiplied by a factor of 168, 84, 42, 7, or 1 depending on the priority setting for the folder. The result of this calculation is a precedence value for each shared folder. The shared folder with the highest calculated precedence is backed up next. Depending on the size of the network and amount of data to be backed up, using the factors of the embodiment set forth above, this translates into the backup device 10 attempting to back up each shared folder marked “as often as possible” every hour, “frequently” every two hours, “periodically” every 4 hours, “occasionally” every 24 hours, and “rarely” every seven days. The precedence value accounts for computers, such as laptops which are connected periodically to the network. When a laptop computer is connected to the network, it may be given precedence for backup based upon the time since it was last backed up.

Alternatively, a shared folder may be marked for timed backup. This means that it is backed up at the same time each day or some other interval (e.g. every Monday, every 3 days, etc.). When it comes time for a shared folder set to timed backup to be backed up, it is placed at the top of the priority list, ahead of all folders with Round Robin scheduling. Timed backups are represented in the user interface as a clock 236. Of course, other combinations or relations between timed and round-robin scheduling may be used. For example, folders or files with timed backups may be given a precedence value such that some round-robin backups would precede a timed backup. Those of skill in the art will envision many such variations.

Multiple backup streams can be used to expedite the backup process. According to an embodiment of the invention, an algorithm is used to determine when it is appropriate to create a new backup stream to begin a backup (vs. waiting until a current backup stream completes its work). The algorithm takes into account:

whether the backup is scheduled via Round Robin or Timed

when the shared folder was last successfully backed up

when a backup of the shared folder was last attempted (but not necessarily completed)

the selected priority of the shared folder, if using Round Robin scheduling

whether there are any other shared folders on the same computer already being backed up.

As with the selection scheme, the backup scheduling algorithms may be used in connection with any scheduling system for improved operation. All backup systems require a schedule for determining timing of backup processes. The scheduling process described above may be used for any such backup system, not just with the backup device of the present invention. For example, the backup device of the present invention is a separate component within a computer network and functions without having to add software to computers on the network. Other backup systems operate as software on the computers. Such backup systems also must schedule times at which to backup files. The scheduling process of the present invention may be used in such systems.

Also, other types of systems require scheduling processes. Many computer system include processes for checking for automatic updates of software from a website operated by the software provider. The updates from different programs may conflict when operating independently. The scheduling process may be used for supporting such processes. Those of ordinary skill in the art will recognize other applications for use of the scheduling process of the present invention. Any system which performs multiple periodic events at different timing intervals could utilize the scheduling process of the present invention.

Once the folders are appropriately identified for backup and scheduling, the backup device operates automatically to perform the backup process. According to an embodiment of the invention, the backup device begins the backup process immediately when connected to the network. Through the use of default values for selection and timing, as discussed above, folders and files are automatically identified for backup. When the backup device initially retrieves a file directory from a computer, the files within that directory, if selected, are backup up immediately. The system then descends each subdirectory and backs up selected files. In this manner, the entire list of files for a computer does not need to be retrieved at once. Each directory and subdirectory is retrieved as needed. This allows efficient use of file list accesses and release of memory having file lists. Of course, other procedures could be used to retrieve lists of files and perform backups of the selected files.

In order to perform the backup process, at the determined time, the backup device accesses the next folder for backup. The folder is scanned to determine any new or changed files. All new or changed files are copied to the memory 120 of the backup device 10 for processing. Each file is processed by first calculating a 160 bit file digest. The digest is a unique number that is calculated by “digesting” a file with a special purpose algorithm, such as the public “sha1” digest method. If two numbers or “digests” are identical, the files are assumed to be identical. The backup copy of the data for that file is given a file name that is the hexadecimal value of the digest. The file digests portion 152 of the index 150 is used to determine files on the network having identical content. If a file digest already exists, the data from the current file is not stored. Instead, the entry in the file tree is associated with the existing file having the same digest value. Therefore, all identical files anywhere on the network are backed up only once, not once for each copy of the same file.

If the file is new or changed, so that it has a unique digest, the file is converted to a compressed and encrypted form. The encryption keys are unique to the particular backup device. Thus, others cannot use similar devices for reading the data once backed up. The data is protected automatically without user intervention. After compression and encryption, the data is checked. This is done by reading the stored data, decrypting and decompressing the file and comparing it to the original file. If the files match, the encrypted file is stored in the Current portion 161 of the DVD images 160. Of course, those skilled in the art could devise other orders of operation for checking/verifying the data, choosing, for example, to re-read the original file, compress and encrypt it, and compare the result to the compressed, encrypted saved file.

A two-level hierarchy of directories is used for storing files within the backup system. This hierarchy allows files to be quickly accessed for restoration. The first level consists of 256 directories named with hexadecimal values 00 through FF. Each of these directories contains a second level of up to 256 directories also named 00 through FF. Each backup file, which is given the name of its digest, is stored in the backup file system in the second-level directory whose name is the same as digits 3 and 4 of its digest file name, and is contained in the first-level directory whose name is the same as digits 1 and 2 of its file name. For example, a file whose digest begins 9ABC . . . is stored in directory BC within directory 9A. This has the effect of dividing potentially thousands of files over 65,536 directories for efficiency of location and retrieval from the file system. The file name automatically identifies the appropriate directory, without any sort of database or indirect lookup. Of course, other hierarchical directory structures could be used which utilize the values of the digest names. The levels may include more or fewer directories based upon more or fewer digits of the file name. Additional levels of directories may also be used.

In order to control data sizes, files that are larger than an arbitrary size (for example, 800 MB in an embodiment of the invention) are broken into chunks of that size and each chunk is treated as a separate file within the backup device 10. The Index 150 keeps track of which chunks are part of each large file. The chunks are treated within the file digests 153 and the data storage 160 as if they were individual files; the chunks that constitute a file may therefore be stored on the same or on different DVDs. This allows files larger than a single DVD to be efficiently backed up. It also helps prevent wasting space on DVDs. Furthermore, it may reduce the amount of stored data. In the event that there are large files which contain the same 800 MB chunk, extra copies of this chunk will not be saved since they will correspond to a digest already in the system.

When the Current area 161 is full, the system has enough data for a single DVD. The data is then converted to a DVD image file and stored in one of the disc images 162-164. If all of the disc images are used, the oldest one is overwritten, as long as it has already been written to the DVDs. The data does not need to be written to a DVD when it is stored in one of the disc images. The backup process continues, uninterrupted, whether or not physical media is present. The process would only stop if all of the DVD image files are full without any having been written to DVD. When the Current area 161 is written to an image file, the administrator is notified, such as by email, or onscreen if the user interface is active, to insert a blank DVD into the DVD drive 130. The system also provides information for the administrator to write by hand (for example, with felt-tip pen or marker) on the blank DVD for identification. Alternatively, a label could be created and printed for the DVD, or a DVD printer could be used to print the information automatically on the DVD.

When notified, the administrator inserts a blank DVD into the DVD drive. The earliest DVD image is written to the DVD. The data is read from the DVD and checked with the DVD image to ensure that the write process was error free. By default, two DVDs are made for each DVD image. One can be maintained onsite and the other taken offsite.

Each week or other selected time, a snapshot DVD is made of the Current area 161. The snapshot DVD contains the contents-in-progress of the next full DVD. This ensures that all data is backed up on physical media, in addition to the hard drive of the backup device, at least once per week or alternative selected interval. If a fire or other disaster destroys the network and backup device, all data is protected up until the time the most recent snapshot DVD was created. A snapshot DVD can be disposed of when the next one is created, since each one includes all of the data in the Current area. The administrator can manually create a snapshot DVD at any time through the user interface.

In addition to backing up new and changed files, all selected files are backed up at least once every six months or other selected time. Other criteria may be used to determine times at which to backup all files. The time period may be calculated based upon the amount of data backed up over a period of time or the number of DVD images that are held in the disc images 162-164. Also, the timing of the periodic backups may be staggered over a period of time for different files, folders or computers. Staggering avoids a sudden increase in data backups and number of DVDs which need to be written. The process can be spread over several months as long as all files end up being backed up periodically. Periodically backing up all files reduces the number of DVD discs which are required to complete certain restore requests, specifically requests which contain a mix of files created over a long period of time.

All historical information is included in the Index. The backup device can recover files that existed on the computer network at any time they were backed up, beginning from the first time a file was ever backed up. This historical record is invaluable when data corruption or file loss is not detected immediately. It is essential when audit, regulatory, ISO 9000, or legal requirements demand access to historical information that has been long dormant or may have been deleted. In order to preserve all historical information, all DVD's should be maintained. Additionally, the index is stored on each DVD when created. If the backup device fails or is destroyed, all historical information remains available.

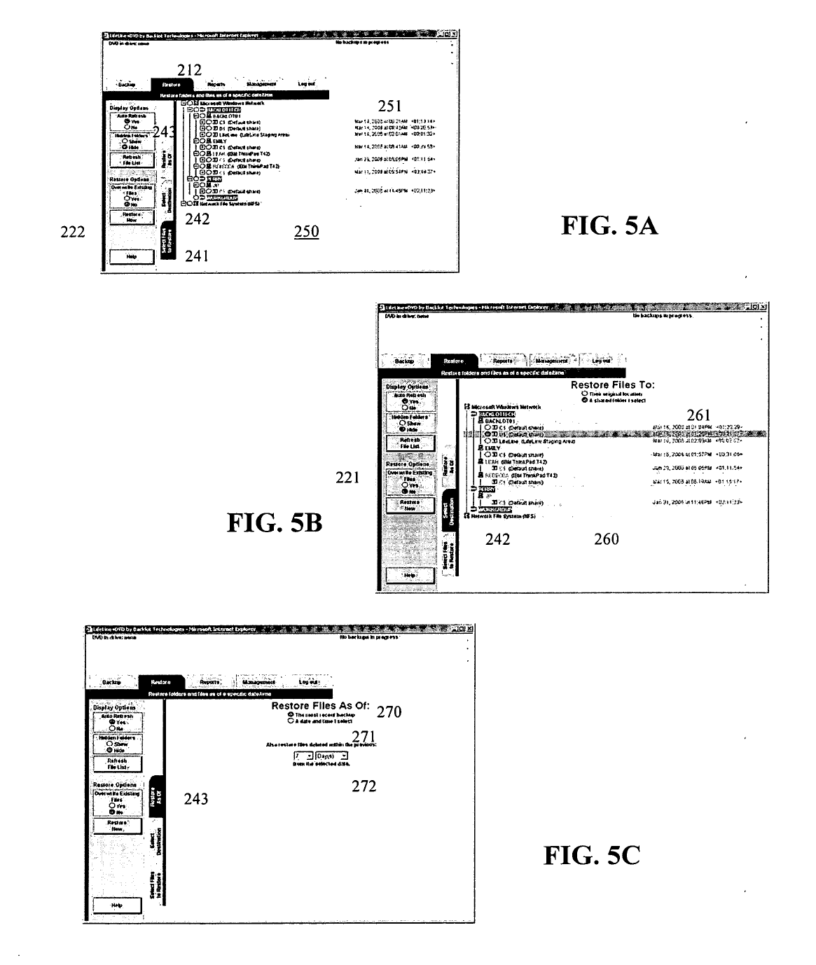

Data can be restored at several different levels, including files, folders, or computers. FIGS. 5A-5C illustrate the user interface for restoring files. FIG. 5A illustrates the user interface of FIG. 4 when the Restore tab 212 is selected. The process for restoring data commences with this interface. The restore process has three screens for setting options, which are selected by tabs 241-243. In the first screen, selected by tab 241, a listing of files 250 which have been backed up is displayed. As with the file list illustrated in FIG. 4, the listing under the restoration interface provides a tree structure 250, retrieved from the file tree 152 of the index 150, which allows the user to expand or collapse the tree. With each file is an indication 251 of when the file was last backed up, including the date and time. If more than one version of a file has been backed up, the tree 250 is expandable to list all versions. One or more versions of a file can be restored. If multiple versions of a file are restored, each will be given a filename which indicates when it was backed up. This lets the user recover easily any file as it existed at a certain time in the past.

The four state selection scheme used to identify files to be backed up is also used to select files to be restored. Folders and/or files are selected. The states of each folder are determined based upon the selection of the folder and any exceptions with respect to its subfolders and files. An exception tree can be used to represent the selection states of the folders and files in the restore process. Additionally, exception rules may be used within the restore process in the same manner as in the backup process.

After specific files have been selected to be restored, the location to put the restored files must be selected. This is done on the second screen, illustrated in FIG. 5B, which is chosen with tab 242. This screen provides a file tree 260 for the current network. It includes all computers and shared folders currently available. The user may select 261 to have the files restored to their original locations. Alternatively, the user may select a specific computer and folder in which to place the stored file. This can be particularly useful if a computer fails. The files from that computer can be easily restored to a replacement computer, which may not have been on the network when the backup files were created. The user may select 221 whether to have the restored files overwrite existing files with the same name. If overwriting is not selected, any files with existing names will not be restored.

The third screen of the restore process, selected with tab 243, provides a simple process for returning a computer to a previous state. This screen allows the user to select a time period from which to restore the files. The user can restore files relating to the most recent backup 271 or to restore files from a specific date 272. The system will determine all files which existed in a selected folder (or computer) and restore the backup of those files from the selected date. Furthermore, the user may have deleted files from the selected folder before the selected backup time and these files should also be restored. The user can input a time interval 273, in hours, days, weeks, months, or years, that specifies that any files deleted during that interval prior to the selected backup time are also to be restored. For example, if the user asks for a folder to be restored as of the most recent backup, with a deleted files interval of 7 days, then files that existed at the time of the last backup will be restored, as will any files deleted within the past 7 days. If the user wants to restore all files that existed in a folder any time in January, he can specify to backup the folder as of February 1, with a deleted files interval of 31 days. In an alternate embodiment, the user could specify this interval in various manners, for example by entering a beginning and ending date/time.

Once all of the necessary selections have been made, the user clicks on Restore Now 222. The system then retrieves all of the backup data and restores it to the designated location. All of the data must be read from a backup source, decrypted and decompressed. Recently backed up data resides in the memory of the backup device, either in the Current area 161 or one of the Disc images 162, 163, 164. This data can be retrieved and restored very quickly and without the need to access any of the backup DVDs. Data which is not in the backup device 10 must be retrieved from the DVDs. The system notifies the user which DVD or DVDs to load in order to retrieve the necessary data.

Security of the backup data is an important requirement for the backup device 10. Security may be achieved in many different manners. However, according to an embodiment of the invention, security is obtained through an encryption process. All data is encrypted when it is backed up. The encryption key is associated with a single backup device. Thus, another backup device, even of the same design, cannot be used to retrieve data from the backup discs. Access to the backup device is through a secure graphical user interface that establishes a secure communication link. Access to the user interface is controlled by a pass phrase chosen by the administrator.

As part of the initialization process, the backup device creates a secure and unique software encryption key. The key is stored in the backup device, but not on any of the computers on the network. All data is transferred to the backup device before it is encrypted. This prevents the encryption key from being distributed over the network or accessible from computers connected to the network. The key cannot be lost or stolen. The user doesn't have to remember the key. The encryption key is also written to one or more Key Discs. These discs should be stored in secure locations separate from the backup device and the data DVDs. A Key Disc is used to gain access to the backup device or the data in the event of a device malfunction. For example, if the backup device with the encryption key is destroyed, such as in a fire, the Key Disc can be used to initialize a new backup device, which will be able to read and decrypt the backed up data.

The Key Disc can also be used for access after other types of failures. For example, if the administrator forgets the password for the user interface, the Key Disc can be used to access the backup device for purposes of resetting the password. The Key Disc can be used to reset network settings for the backup device so that it can become accessible after a possible network problem. The Key Disc may also be used to completely purge all data from the backup device, such as when a physical device is being disposed of.

The process for control of encryption within the backup device of the present invention may also be used for other types of systems. Encryption is used in many different contexts. A user may wish to encrypt all of the data, or some subset, on the computer to prevent unauthorized access. It is common to encrypt information when sending it through email or other electronic means. Off-site access to a network may also require encryption of information being sent through public or insecure networks. All of these encryption operations may utilize functionality of the encryption process used in the backup system of the present invention. An encryption key may be specific to a particular machine. The encryption key may be required to store and retrieve information. Additional copies of the key on removable media may be created for additional control. The removable copies can be required for resetting certain or all parameters of a device. The removable copy may also be used for initializing a replacement device. The removable copies may be used for accessing certain login information, such as usernames and passwords, which have been forgotten or lost. Those of ordinary skill in the art will recognize other possible uses of the encryption process of the present invention in other contexts and other devices.

In addition to the security needs, the database in the backup device 10 should be protected from intrusion by others. Such intrusion may include reverse engineering of the design and operation of the database. The present invention includes a database creation tool for encrypting the database structure. Simple encryption of the information could cause performance degradation and would make updating the software more difficult. The database creation tool operates as a preprocessor on the database schema definition and the software code that references it. The preprocessor changes the names of every table and column definition (and trigger, view, index, etc.) in the database to a meaningless name. The name may be random or a one-way encryption or digest of the original name. This will make it much more difficult to reverse-engineer the database schema. By using a digest, a one-way encryption of the actual table and column names, the obfuscated names will never be inadvertently changed. Database debugging, or manual manipulation for other purposes, can be easily accomplished with the non-obfuscated names. A database utility includes the same digest system. Thus, the database utility can receive non-obfuscated names and generate their digests to use as input to the debug database queries. The queries will return the proper data based upon the digested name. However, the table and database structure cannot be easily determined from the obfuscated names.

The database obfuscation process described above can be used for any type of confidential database structure. It is not limited to the backup device of the present invention. All databases have some level of confidentiality. When the structure itself is significant, the use of a preprocessor can be used to hide the database structure within any such database.

Having disclosed at least one embodiment of the present invention, various adaptations, modifications, additions, and improvements will be readily apparent to those of ordinary skill in the art. Such adaptations, modifications, additions and improvements are considered part of the invention.

1. A computer backup device for storing copies of files on at least one computer connected to a network, the device comprising:
a network interface for connecting to the network;
means for accessing the at least one computer through the network interface to retrieve a list of files on the at least one computer;
means for retrieving through the network interface a copy of at least one file from the list of files on the at least one computer; and
storage media for storing the copy of the at least one file.

2. The computer backup storage device according to claim 1 wherein the storage media includes:
a first storage media for storing the copy of the at least one file when retrieved from the at least one computer;
a second storage media for receiving and storing a second copy of the at least one file from the first storage media; and
a processor for transmitting the copy of the at least one file from the first storage media to the second storage media.

3. The computer backup storage device according to claim 2, wherein the first storage media includes a hard drive.

4. The computer backup storage device according to claim 2, wherein the second storage media includes a removable media.

5. The computer backup storage device according to claim 4, wherein the second storage media includes a writable DVD.

6. The computer backup storage device according to claim 2, wherein the processor transmits the copy of the at least one file from the first storage media to the second storage media when a predetermined amount of data has been stored on the first storage media.

7. The computer backup storage device according to claim 2, wherein the processor transmits a copy of the at least one file from the first storage media to the second storage media when a predetermined time has elapsed since a prior transmission from the first storage media to the second storage media.

8. The computer backup storage device according to claim 2, wherein the copy of the at least one file includes copies of a plurality of files; and
wherein the second copy of the at least one file includes a first set of copies of the plurality of files.

9. The computer backup storage device according to claim 8, wherein the processor includes means for storing a second set of copies of the plurality of files on the first storage media.

10. The computer backup storage device according to claim 1 further comprising means for restoring the copy of the at least one file to at least one computer through the network interface.

11. The computer backup storage device according to claim 10 further comprising a first file list identifying copies of files stored on the storage media and wherein the means for restoring includes means for selecting the copy of the at least one file in accordance with information in the first file list identifying the copy of the at least one file.

12. The computer backup storage device according to claim 11 wherein the storage media includes:
a first storage media for storing the copy of the at least one file when retrieved from the at least one computer;
a plurality of removable second storage media for receiving and storing a second copy of the at least one file from the first storage media; and
a processor for transmitting the copy of the at least one file from the first storage media to one of the plurality of second storage media; and
wherein the means for restoring includes means for identifying one of the plurality of second storage media containing the copy of the at least one file.

13. The computer backup storage device according to claim 11 wherein the copy of at least one file includes copies of a plurality of versions of the at least one file; and
wherein the means for restoring includes:
means for displaying a list of the plurality of versions of the at least one file; and
means for receiving an input specifying at least one of the plurality of versions of the at least one file to be restored.

14. The computer backup storage device according to claim 11 further comprising:
file digest means for creating a digest value based upon the contents of a file; and
wherein a file is identified in the first list of files by its corresponding digest value.

15. The computer backup storage device according to claim 14 wherein the storage media includes a file directory system having a plurality of folders; and
wherein the copy of the at least one file is stored on the storage media within a folder of the file directory system based upon a first portion of a corresponding digest value.

16. The computer backup storage device according to claim 15 wherein the file directory system includes a plurality of subfolders with each of the plurality of folders; and
wherein the copy of the at least one file is stored on the storage media within a subfolder of the file directory system based upon a second portion of a corresponding digest value.

17. A computer backup system comprising:
a plurality of computers connected in a network; and
a backup device including:
a network interface for connecting to the network;
means for accessing at least one of the plurality of computers through the network interface to retrieve a list of files on the at least one computer;
means for retrieving through the network interface a copy of at least one file from the list of files on the at least one computer; and
storage media for storing the copy of the at least one file.

18. The computer backup system according to claim 17 wherein the storage media includes:
a first storage media for storing the copy of the at least one file when retrieved from the at least one computer;
a second storage media for receiving and storing a second copy of the at least one file from the first storage media; and
a processor for transmitting the copy of the at least one file from the first storage media to the second storage media.

19. The computer backup system according to claim 18, wherein the first storage media includes a hard drive.

20. The computer backup system according to claim 18, wherein the second storage media includes removable media.

21. The computer backup system according to claim 20, wherein the second storage media includes a writable DVD.

22. The computer backup system according to claim 18, wherein the processor transmits the copy of the at least one file from the first storage media to the second storage media when a predetermined amount of data has been stored on the first storage media.

23. The computer backup system according to claim 18, wherein the processor transmits a copy of the at least one file from the first storage media to the second storage media when a predetermined time has elapsed since a prior transmission from the first storage media to the second storage media.

24. The computer backup system according to claim 18, wherein the copy of the at least one file includes copies of a plurality of files; and
wherein the second copy of the at least one file includes a first set of copies of the plurality of files.

25. The computer backup system according to claim 24, wherein the processor includes means for storing a second set of copies of the plurality of files on the first storage media.

26. The computer backup system according to claim 17 further comprising means for restoring the copy of the at least one file to at least one computer through the network interface.

27. The computer backup system according to claim 26 further comprising a first file list identifying copies of files stored on the storage media and wherein the means for restoring includes means for selecting the copy of the at least one file in accordance with information in the first file list identifying the copy of the at least one file.

28. The computer backup system according to claim 27 wherein the storage media includes:
a first storage media for storing the copy of the at least one file when retrieved from the at least one computer;
a plurality of removable second storage media for receiving and storing a second copy of the at least one file from the first storage media; and
a processor for transmitting the copy of the at least one file from the first storage media to one of the plurality of second storage media; and
wherein the means for restoring includes means for identifying one of the plurality of second storage media containing the copy of the at least one file.

29. The computer backup system according to claim 27 wherein the first file list includes a hierarchical organization of files within folders; and
wherein the means for restoring includes means for selecting folders and files within the hierarchical organization to select the at least one file.

30. The computer backup system according to claim 29 wherein a selection state of a folder relates to its own state and the states of all files under the folder within the hierarchical organization.

31. The computer backup system according to claim 27 wherein the copy of at least one file includes copies of a plurality of versions of the at least one file; and
wherein the means for restoring includes:
means for displaying a list of the plurality of versions of the at least one file; and
means for receiving an input specifying at least one of the plurality of versions of the at least one file to be restored.

32. The computer backup system according to claim 27 further comprising:
file digest means for creating a digest value based upon the contents of a file; and
wherein a file is identified in the first list of files by its corresponding digest value.

33. The computer backup system according to claim 32, further comprising means for comparing a digest value with the first list of files; and
wherein a file is not copied if the digest value is in the first list of files.

34. The computer backup system according to claim 27, wherein the first file list includes a time at which copies of files were stored on the storage media, and
wherein the means for selecting includes:
means for selecting a date; and
means for identifying the copy of the at least one file which existed as of the date.

35. The computer backup system according to claim 34, wherein the means for selecting further includes:
means for selecting a date range; and
means for identifying the copy of the at least one file which was deleted during the date range.

36. The computer backup system according to claim 32 wherein the storage media includes a file directory system having a plurality of folders; and
wherein the copy of the at least one file is stored on the storage media within a folder of the file directory system based upon a first portion of a corresponding digest value.

37. The computer backup system according to claim 36 wherein the file directory system includes a plurality of subfolders with each of the plurality of folders; and
wherein the copy of the at least one file is stored on the storage media within a subfolder of the file directory system based upon a second portion of a corresponding digest value.

38. A method for backing up at least one file on at least one computer connected to a network, the method comprising the steps of:
accessing the at least one computer through the network interface to retrieve a list of files on the at least one computer;
retrieving through the network interface a copy of at least one file from the list of files on the at least one computer; and
storing the copy of the at least one file.

39. The method for backing up a computer according to claim 38 wherein the storing step includes:
storing the copy of the at least one file on a first storage media when retrieved from the at least one computer; and
transmitting a copy of the at least one file from the first storage media to a second storage media.

40. The method for backing up a computer according to claim 39, wherein the first storage media includes a hard drive.

41. The method for backing up a computer according to claim 39, wherein the second storage media includes removable media.

42. The method for backing up a computer according to claim 41, wherein the second storage media includes a writable DVD.

43. The method for backing up a computer according to claim 39, wherein the copy of the at least one file is transmitted from the first storage media to the second storage media when a predetermined amount of data has been stored on the first storage media.

44. The method for backing up a computer according to claim 39, wherein a copy of the at least one file is transmitted from the first storage media to the second storage media when a predetermined time has elapsed since a prior transmission from the first storage media to the second storage media.

45. The method for backing up a computer according to claim 39, wherein the copy of the at least one file includes copies of a plurality of files; and
wherein the second copy of the at least one file includes a first set of copies of the plurality of files.

46. The method for backing up a computer according to claim 45, further comprising the step of storing a second set of copies of the plurality of files on the first storage media.

47. The method for backing up a computer according to claim 38 further comprising the step of restoring the copy of the at least one file to at least one computer through the network interface.

48. The method for backing up a computer according to claim 47 wherein the restoring step includes selecting the copy of the at least one file in accordance with information stored in a first file list identifying the copy of the at least one file.

49. The method for backing up a computer according to claim 48 wherein the first file list includes a hierarchical organization of files within folders; and
wherein the step of selecting the copy of the at least one file includes selecting folders and files within the hierarchical organization.

50. The method for backing up a computer according to claim 49 wherein a selection state of a folder relates to its own state and the states of all files under the folder within the hierarchical organization.

51. The method for backing up a computer according to claim 48 wherein the storage media includes:
a first storage media for storing the copy of the at least one file when retrieved from the at least one computer; and
a plurality of removable second storage media for receiving and storing a second copy of the at least one file from the first storage media; and
wherein the restoring step includes the step of identifying one of the plurality of second storage media containing the copy of the at least one file.

52. The method for backing up a computer according to claim 48 wherein the copy of at least one file includes copies of a plurality of versions of the at least one file; and
wherein the step of restoring includes the steps of:
displaying a list of the plurality of versions of the at least one file; and
receiving an input specifying at least one of the plurality of versions of the at least one file to be restored.

53. The method for backing up a computer according to claim 48, wherein the first file list includes a time at which copies of files were stored on the storage media, and
wherein the selecting step includes the steps of:
selecting a date; and
identifying the copy of the at least one file which existed as of the date.

54. The method for backing up a computer according to claim 53, wherein the selecting step further includes the steps of:
selecting a date range; and
identifying the copy of the at least one file which was deleted during the date range.

55. The method for backing up a computer according to claim 48 further comprising the steps of:
creating a digest value based upon the contents of a file; and
identifying a file in the first list of files by its corresponding digest value.

56. The method for backing up a computer according to claim 55 wherein the storage media includes a file directory system having a plurality of folders; and
wherein the copy of the at least one file is stored on the storage media within a folder of the file directory system based upon a first portion of a corresponding digest value.

57. The method for backing up a computer according to claim 56 wherein the file directory system includes a plurality of subfolders with each of the plurality of folders; and
wherein the copy of the at least one file is stored on the storage media within a subfolder of the file directory system based upon a second portion of a corresponding digest value.
